(19) United States
(12) Patent Application Publication
(10) Pub. No.: US 2022/0198523 A1
(43) Pub. Date: Jun. 23, 2022

(54) ELECTRONIC DEVICE AND CONTROL METHOD THEREOF

(71) Applicant: Samsung Electronics Co., Ltd., Suwon-si (KR)

(72) Inventors: Mirae JEONG, Suwon-si (KR); Soohyung KIM, Suwon-si (KR); Junhyuk LEE, Suwon-si (KR); Junbeom KIM, Suwon-si (KR); Goeon PARK, Suwon-si (KR); Wonsuk YANG, Suwon-si (KR)

(21) Appl. No.: 17/670,981

(22) Filed: Feb. 14, 2022

Related U.S. Application Data
(63) Continuation of application No. PCT/KR2021/012267, filed on Sep. 9, 2021.

(30) Foreign Application Priority Data
Dec. 18, 2020 (KR) 10-2020-0178980

(51) Int. Cl. G06Q 30/02

(52) U.S. Cl. CPC G06Q 30/0271; G06Q 30/0267

(57) ABSTRACT

An electronic device is provided. The electronic device includes a communication interface, a memory storing information corresponding to a plurality of user terminals respectively, and a processor configured to identify, based on an advertisement request signal and context information of a display device being received from the display device, at least one user terminal corresponding to context information of the display device from among the plurality of user terminals, identify advertisement information corresponding to the identified user terminal based on the stored information, and transmit the identified advertisement information to the display device through the communication interface.

### CROSS-REFERENCE TO RELATED APPLICATION (S)

This application is a continuation application, claiming priority under § 365(c), of an International application No. PCT/KR2021/012267, filed on Sep. 9, 2021, which is based on and claims the benefit of a Korean patent application number 10-2020-0178980, filed on Dec. 18, 2020, in the Korean Intellectual Property Office the disclosure of which is incorporated by reference herein in its entirety.

### BACKGROUND

### 1. Field

The disclosure relates to an electronic device and a control method thereof. More particularly, the disclosure relates to an electronic device configured to transmit advertisement information and a control method thereof.

### 2. Description of Related Art

With the development of electronic technology, electronic devices of various types are under development and supplied. In particular, methods of providing customized advertisements to users are widely being developed taking into consideration preferences, interests, and the like of users using the electronic device.

Providing user customized advertisements to personal devices such as smartphones, tablet personal computers (PC) with main users is easy, but it is difficult to provide user customized advertisements to shared devices such as a television (TV), refrigerator, or the like which has a plurality of users.

In particular, it is difficult to identify who the user is using the shared device, and after the user is specified, there is a need for finding ways to provide customized advertisement to specified users and a need for discussion associated therewith.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device configured to specify a user and thereafter provide customized advertisements to the specified user and a control method thereof.

In accordance with an aspect of the disclosure, an electronic device is provided. The device includes a communication interface, a memory stored with advertisement information corresponding to a plurality of user terminals respectively, and a processor configured to identify, based on receiving an advertisement request signal from a display device and context information of the display device, at least one user terminal corresponding to context information of the display device from among the plurality of user terminals, identify advertisement information corresponding to the identified user terminal based on the stored information, and transmit the identified advertisement information to the display device through the communication interface.

In accordance with another aspect of the disclosure, a control method of an electronic device is provided. The method includes identifying, based on receiving an advertisement request signal and context information of a display device from the display device, at least one user terminal corresponding to context information of the display device from among the plurality of user terminals, identifying advertisement information corresponding to the identified user terminal based on the stored information, and transmitting the identified advertisement information to the display device.

In accordance with another aspect of the disclosure, a user customized advertisements taking into consideration user interest, preference, and the like and not unilaterally provide advertisements without consideration to the user's interest and preference is provided.

The user may, based on receiving advertisements corresponding to one's interest and preference, consider advertisement as useful information, and a click ratio with respect to the advertisement may be enhanced.

### BRIEF DESCRIPTION OF THE DRAWINGS

FIG. 1 is a diagram illustrating an electronic device, a display device, and a user terminal according to an embodiment of the disclosure;

FIG. 2 is a block diagram illustrating a configuration of an electronic device according to an embodiment of the disclosure;

FIG. 3 is a graph illustrating context information according to an embodiment of the disclosure;

FIG. 4 is a diagram illustrating interest context information according to an embodiment of the disclosure;

FIG. 5 is a diagram illustrating advertisement information stored in an electronic device according to an embodiment of the disclosure;

FIG. 6 is a diagram illustrating advertisement information received by a display device according to an embodiment of the disclosure;

FIG. 7 is a detailed block diagram illustrating a configuration of an electronic device according to an embodiment of the disclosure; and

FIG. 8 is a flowchart illustrating a control method of an electronic device according to an embodiment of the disclosure.

### DETAILED DESCRIPTION

The disclosure will be explained in greater detail below with reference to the accompanying drawings.

The terms used in describing the various example embodiments of the disclosure are general terms selected that are currently widely used considering their function herein. However, the terms may change depending on intention, legal or technical interpretation, emergence of new technologies, and the like of those skilled in the related art.

In the disclosure, expressions such as “comprise,” “may comprise,” “include,” “may include,” or the like are used to designate a presence of a corresponding characteristic (e.g., elements such as numerical value, function, operation, or component, etc.), and not to preclude a presence or a possibility of additional characteristics.

The expression at least one from among A and/or B is to be understood as indicating at least one from among “A” or “B” or “A and B.”

Expressions such as “first,” “second,” “1st,” “2nd,” and so on used herein may be used to refer to various elements regardless of order and/or importance. Further, it should be noted that the expressions are merely used to distinguish an element from another element and not to limit the relevant elements.

When a certain element (e.g., first element) is indicated as being “(operatively or communicatively) coupled with/to” or “connected to” another element (e.g., second element), it may be understood as the certain element being directly coupled with/to another element or as being coupled through other element (e.g., third element).

A singular expression includes a plural expression, unless otherwise specified. It is to be understood that the terms such as “comprise” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The terms “module” or “part” used in the embodiments herein perform at least one function or operation, and may be implemented with a hardware or software, or a combination of hardware and software. Further, a plurality of “modules” or a plurality of “parts,” except for a “module” or a “part” which needs to be implemented to a specific hardware, may be integrated to at least one module and implemented in at least one processor (not shown).

In this disclosure, the term “user” may refer to a person using an electronic device or a device (e.g., artificial intelligence electronic device) using an electronic device.

The embodiments of the disclosure will be described in greater detail below with reference to the accompanied drawings.

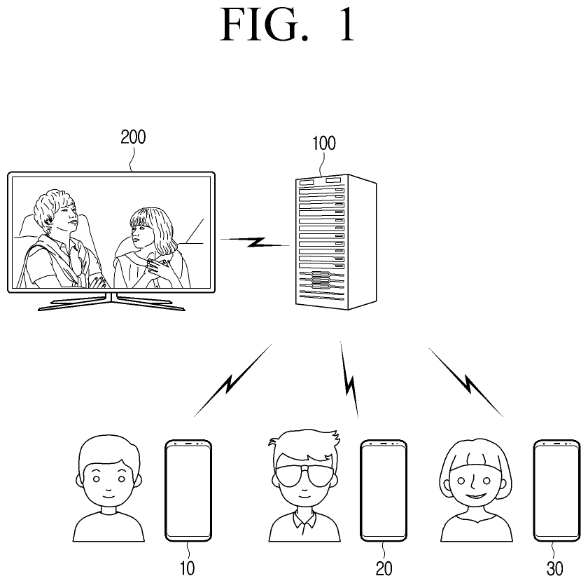

FIG. 1 is a diagram illustrating an electronic device, a display device, and a user terminal according to an embodiment of the disclosure.

The electronic device 100 according to an embodiment may be configured to provide content to the display device 200, the plurality of user terminals 10, 20, and 30, and the like. For example, the electronic device 100 may be implemented as a server and provide advertisement information to the display device 200, the plurality of user terminals 10, 20, and 30, and the like, and the display device 200, the plurality of user terminals 10, 20, and 30, and the like may be configured to provide advertisement to a user through a display installed therein based on advertisement information provided from the server.

For convenience of description, FIG. 1 has been illustrated assuming that the electronic device 100 is a server configured to perform communication with various external devices such as, for example, and without limitation, the display device 200, the plurality of user terminals 10, 20, and 30, and the like, but this is one embodiment, and the embodiment is not limited thereto. In another example, the various embodiments of the disclosure may be performed by the display device 200 itself. In this case, the electronic device 100 and the display device 200 may be implemented as one device and not separate devices.

The electronic device 100, the display device 200, and the respective user terminals 10, 20, and 30 in accordance with various embodiments of the disclosure may include at least one from among, for example, and without limitation, a smartphone, a tablet personal computer (PC), a mobile phone, a video telephone, an electronic book reader, a desktop PC, a laptop PC, a netbook computer, a workstation, a server, a personal digital assistance (PDA), a portable multimedia player (PMP), a 1\fP3 player, a medical device, a camera, a virtual reality (VR) realization device, or a wearable device. The wearable device may include at least one from among an accessory type (e.g., a watch, a ring, a bracelet, an anklet, a necklace, a pair of glasses, a contact lens or a head-mounted-device (HMD)), a fabric or a garment-embedded type (e.g., an electronic clothing), a skin-attached type (e.g., a skin pad or a tattoo), or a bio-implantable circuit.

In some embodiments, the electronic device 100, the display device 200, and the respective user terminals 10, 20, and 30 may include at least one from among, for example, and without limitation, a television, a digital versatile disk (DVD) player, an audio, a refrigerator, an air conditioner, a cleaner, an oven, a microwave, a washing machine, an air purifier, a set top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, an electronic frame, or the like.

In another embodiment, the electronic device 100, the display device 200, and the respective user terminals 10, 20, and 30 may include at least one from among various medical devices (e.g., various portable medical measurement devices (glucose measuring device, a heart rate measuring device, a blood pressure measuring device, a temperature measuring device, etc.), a magnetic resonance angiography (MRA), a magnetic resonance imaging (MRI), a computed tomography (CT), an imaging apparatus, an ultrasonic device, etc.), a navigation device, a global navigation satellite system (GNSS), an event data recorder (EDR), a flight data recorder (FDR), a vehicle infotainment device, a nautical electronic equipment (e.g., nautical navigation device, gyro compass, etc.), an avionics electronic device, a security device, a vehicle head unit, an industrial or personal robot, a drone, an automated teller machine (ATM) of financial institutions, a point of sales (POS) of shops, or an internet of things (IoT) device (e.g., light bulbs, various sensors, sprinkler devices, fire alarms, temperature adjusters, street lights, toasters, exercise equipment, hot water tanks, heater, boilers, etc.).

As illustrated in FIG. 1, the display device 200 may be assumed as a television, the respective user terminals 10, 20, and 30 may be assumed as any one from among a smartphone or a tablet PC, and the electronic device 100 may be assumed as a server configured to perform communication with the display device 200 and the respective user terminals 10, 20, and 30 and provide advertisement information for convenience of description.

Specifically, the display device 200 may be a television provided within a home, and the display device 200 may be used by members within the home, that is a plurality of users, and not specific users using the display device 200 only.

On the other hand, the respective user terminals 10, 20, and 30 may be used mainly by a specific user only. The display device 200 used by the plurality of users may be referred to as a shared device, and the user terminals 10, 20, and 30 used mainly by specific users only may be referred to as a private device.

Referring to FIG. 1, the private device, that is, the respective user terminals 10, 20, and 30, may be configured to comprehend a preference, interest, and the like of a main user and then provide optimized advertisement to the main user based thereof. For example, the electronic device 100 may be configured to obtain search history information, content viewing history information, and the like of a first user terminal 10, and provide an optimized advertisement to the first user terminal 10 based on the obtained information. Further, the first user terminal 10 may be configured to output the advertisement provided from the electronic device 100. The corresponding advertisement may have high relevance with the preference and interest of the main user of the first user terminal 10.

On the other hand, a display device of the related art may provide advertisements which reflect the preferences and interests of all members within the home that is, the plurality of users. For example, the electronic device 100 may be configured to provide, after identifying specific users (e.g., users currently using the shared device) from among the plurality of users using the shared device (e.g., the television provided within the home), advertisements which reflected the preferences and interests of all the plurality of users because of the difficulty in providing only the advertisements reflecting the preferences and interests of the identified specific users. In this case, there may be the problem of the advertisement output by the shared device having low relevance with the preference and interest of the specific user (e.g., the user currently using the shared device).

Various embodiments of the electronic device 100 identifying the specific user (e.g., the user currently using the shared device) from among the plurality of users using the shared device, and then providing an advertisement (e.g., an advertisement having high relevance with the preference and interest of the specific user) optimized to the identified specific user will be described below.

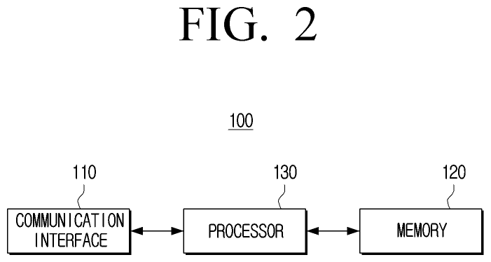

FIG. 2 is a block diagram illustrating a configuration of an electronic device according to an embodiment of the disclosure.

Referring to FIG. 2, the electronic device 100 according to an embodiment may include a communication interface 110, a memory 120, and a processor 130.

The communication interface 110 according to an embodiment may receive input of various data. For example, the communication interface 110 may receive various data from an external device (e.g., display device 200, plurality of user terminals 10, 20, and 30), an external storage medium (e.g., universal serial bus (USB) memory), an external server (e.g., Webhard), or the like through a communication method such as, for example, and without limitation, an access point based wireless-fidelity (Wi-Fi) (e.g., Wi-Fi, wireless local area network (LAN)), Bluetooth, ZigBee, a wired/wireless LAN, a wide area network (WAN), Ethernet, IEEE 1394, a high-definition multimedia interface (HDMI), USB, a mobile high-definition link (MHL), Audio Engineering Society/European Broadcasting Union (AES/EBU), Optical, Coaxial, or the like.

The memory 120 may be configured to store data required for the various embodiments of the disclosure. The memory 120 may be implemented in the form of a memory embedded in the electronic device 100 according to a data storage use, or in the form of a memory detachable from the electronic device 100.

For example, the data for operating the electronic device 100 may be stored in a memory embedded to the electronic device 100, and data for an expansion function of the electronic device 100 may be stored in a memory detachable from the electronic device 100. The memory embedded in the electronic device 100 may be implemented as at least one from among a volatile memory (e.g., a dynamic random access memory (RAM) (DRAM), a static RAM (SRAM), a synchronous dynamic RAM (SDRAM), etc.), or a non-volatile memory (e.g., one time programmable read only memory (ROM) (OTPROM), programmable ROM (PROM), erasable and programmable ROM (EPROM), electrically erasable and programmable ROM (EEPROM), mask ROM, flash ROM, a flash memory (e.g., NAND flash or NOR flash), a hard disk drive (HDD) or a solid state drive (SSD)). In the case of a memory detachable from the electronic device 100, the memory may be implemented in a form such as, for example, and without limitation, a memory card (e.g., a compact flash (CF), a secure digital (SD), a micro secure digital (micro-SD), a mini secure digital (mini-SD), an extreme digital (xD), a multi-media card (MMC), etc.), an external memory (e.g., USB memory) connectable to a USB port, or the like.

The memory 120 according to an embodiment may be configured to store at least one instruction for controlling the electronic device 100 or a computer program including instructions.

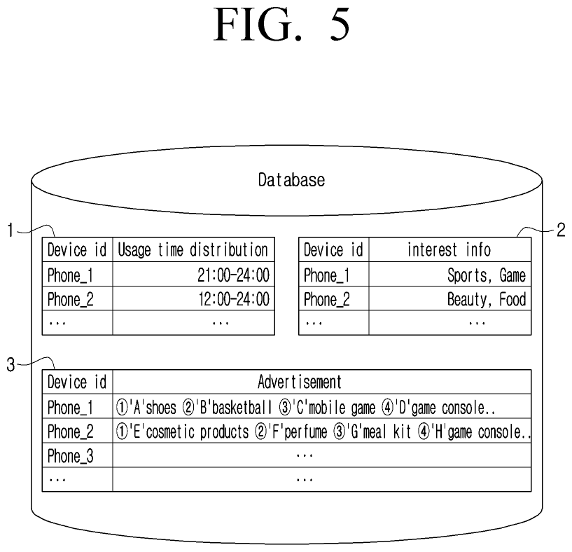

The memory 120 according to an embodiment may be configured to store advertisement information which correspond to the respective user terminals 10, 20, and 30. For example, identification information (e.g., Device ID) of the first user terminal 10 and advertisement information which corresponds to the identification information may be stored. The detailed description thereof will be described below with reference to FIG. 5.

The processor 130 according to an embodiment may be configured to control the overall operation of the electronic device 100.

The processor 130 according to an embodiment may be implemented as a digital signal processor (DSP), a microprocessor, a graphics processing unit (GPU), an artificial intelligence (AI) processor, a neural processing unit (NPU), and a time controller (TCON). However, the embodiment is not limited thereto, and may include, for example, and without limitation, one or more from among a central processing unit (CPU), a micro controller unit (MCU), a micro processing unit (MPU), a controller, an application processor (AP), a communication processor (CP), an advanced reduced instruction set computer (RISC) machine (ARM) processor, or the like, or may be defined by the corresponding term. In addition, the processor 130 may be implemented as a System on Chip (SoC) or large scale integration (LSI) embedded with a processing algorithm, and may be implemented in the form of an application specific integrated circuit (ASIC) or a field programmable gate array (FPGA)

Specifically, the processor 130 according to an embodiment may be configured to identify, based on receiving an advertisement request signal and context information of the display device 200 from the display device 200 through the communication interface 110, at least one user terminal corresponding to context information of the display device 200 from among the plurality of user terminals 10, 20, and 30.

Referring to FIG. 1, the plurality of user terminals 10, 20, and 30 may be devices associated with the display device 200.

For example, the display device 200, the refrigerator, the desktop computer, and the like provided within the home may correspond to shared devices which are used by the members within the home that is, the plurality of users. As an alternative concept to the shared device, smartphones, tablet PCs, and the like which are used mainly by the specific user and rarely used by other users may correspond to a private device.

The electronic device 100 according to an embodiment may be configured to identify, based on receiving the advertisement request signal from the shared device (e.g., display device 200) and the context information, the personal device (e.g., the plurality of user terminals 10, 20, and 30) associated with the shared device.

According to an embodiment, the private devices of members within the home which includes the shared devices may be mapped with the shared devices and pre-registered in the electronic device 100. For example, the plurality of user terminals 10, 20, and 30 used by the members within the home in which the display device 200 is provided on the electronic device 100 may be pre-registered as a private device associated with the display device 200.

The processor 130 may be configured to identify, based on receiving the advertisement request signal and the context information from the display device 200, the plurality of user terminals 10, 20, and 30 pre-registered as a private device which is associated with the display device 200.

Further, the processor 130 may be configured to identify at least one user terminal which corresponds to the context information of the display device 200 from among the plurality of user terminals 10, 20, and 30.

For example, the context information of the display device 200 may include location information of the display device 200. In this case, the processor 130 may be configured to identify, based on location information being received from the respective user terminals 10, 20, and 30, at least one user terminal device which is located adjacent to the display device 200 from among the plurality of user terminals 10, 20, and 30 based on the location information of the display device 200 and the location information of the respective user terminals 10, 20, and 30.

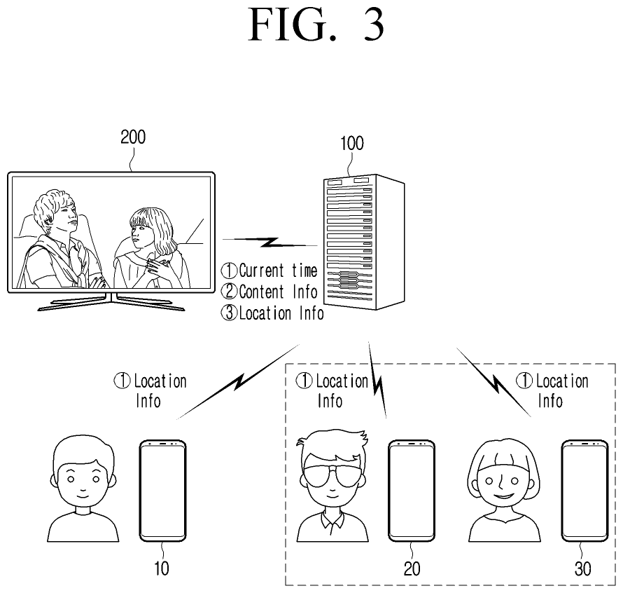

The detailed description thereof will be provided below with reference to FIG. 3.

FIG. 3 is a graph illustrating context information according to an embodiment of the disclosure.

Referring to FIG. 3, the processor 130 may be configured to identify, based on context information of the display device 200 being received, at least one user terminal from among a first to third user terminals 10, 20, and 30 based on the context information of the display device 200.

In an example, the context information of the display device 200 may include at least one from among \textcircled{1} a current time at which the advertisement request signal is received, \textcircled{2} content information currently being provided through the display device 200, and \textcircled{3} location information of where the display device 200 is provided.

First, the location information of the display device 200 being included in the context information received from the display device 200 may be described.

The processor 130 according to an embodiment may be configured to compare the location information of the respective user terminals 10, 20, and 30 and the location information of the display device 200 received through the communication interface 110 and identify at least one user terminal which is located adjacent to the display device 200.

Referring to FIG. 3, first user terminal 10 being located adjacent to the display device 200, and second and third user terminals 20, and 30 not being located adjacent to the display device 200, have been illustrated

The processor 130 according to an embodiment may be configured to determine, based on the first user terminal 10 being identified as located adjacent to the display device 200, that the main user of the first user terminal 10 is currently using the display device 200. Accordingly, the processor 130 may be configured to transmit advertisement information having high relevance with the preference and interest of the main user of the first user terminal 10 to the display device 200. Then, the display device 200 may be configured to output an advertisement based on the received advertisement information.

The location information may refer to base station information through which the display device 200 and the user terminal perform communication, and information obtained through a coordinate value of a global positioning system (GPS) terminal provided in the display device 200 and the user terminal, radio frequency identification (RFID), and the like, and is not limited thereto. For example, the location information may be set according to a user input, and obtained based on various communication methods which identify the current location of the display device 200 and the user terminal.

The processor 130 may be configured to determine, based on the first user terminal 10 being identified as located within a threshold distance from the display device 200, the first user terminal 10 as being located adjacent to the display device 200. Here, the threshold distance may be within 20 m, and may be changed variously according to a user setting, object of a manufacturer, or the like.

In another example, the processor 130 may be configured to identify at least one user terminal which is located adjacent to the display device 200 based on communication network information included in the context information of the display device 200.

For example, the context information of the display device 200 may include information on a communication network to which the display device 200 is connected. In this case, the processor 130 may be configured to obtain communication network information from the respective user terminals 10, 20, and 30.

Then, the processor 130 may be configured to identify at least one user terminal which is located adjacent to the display device 200 from among the plurality of user terminals 10, 20, and 30 based on the communication network information of the display device 200 and the communication network information of the respective user terminals 10, 20, and 30.

For example, the communication network information may include a Public IP, a Mac address, connected access point information and the like. The processor 130 may be configured to identify at least one user terminal which includes the same Public IP from among the Public IPs included in the communication network information of the display device 200 and the communication network information of the respective user terminals 10, 20, and 30.

In another example, the processor 130 may be configured to identify at least one user terminal connected to the same communication network as the display device 200 based on a Mac address included in the communication network information of the display device 200 and a Mac address included in the communication network information of the respective user terminals 10, 20, and 30.

In still another example, the processor 130 may be configured to identify at least one user terminal connected to the same AP as the display device 200 based on AP information included in the communication network information of the display device 200 and the AP information included in the communication network information of the respective user terminals 10, 20, and 30.

The processor 130 according to an embodiment may be configured to obtain advertisement information which corresponds to the identified at least one user terminal after determining the identified at least one user terminal as being located adjacent to the display device 200. Then, the processor 130 may be configured to provide the obtained advertisement information to the display device 200.

The context information of the display device 200 according to an embodiment may include content information which is currently being provided in the display device 200. Here, the content information may include a name of a content, a genre of the content, a format (e.g., resolution, moving image, still image, number of sound channels, etc.) of the content, reviews associated with the content (or, average rating), a release schedule of the content, a subject of the content, and the like.

Then, the processor 130 may be configured to obtain content information of interest of the respective user terminals 10, 20, and 30. For example, the processor 130 may be configured to obtain search history information of the respective user terminals 10, 20, and 30.

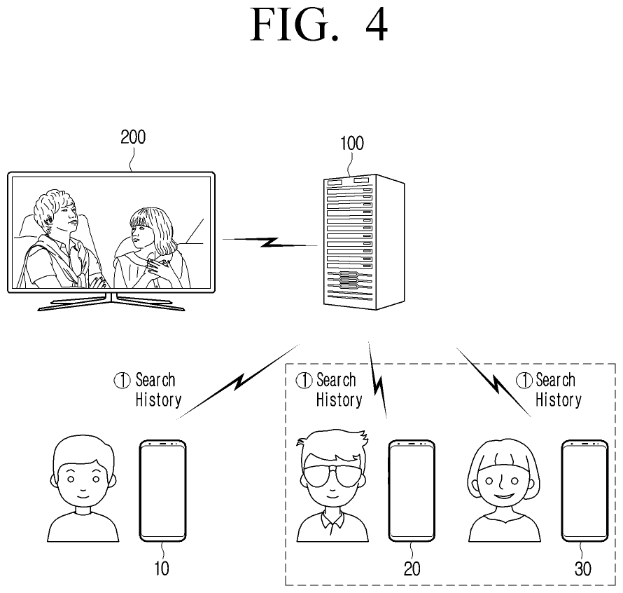

The detailed description thereof will be provided below with reference to FIG. 4.

FIG. 4 is a diagram illustrating interest context information according to an embodiment of the disclosure.

Referring to FIG. 4, the electronic device 100 according to an embodiment may be configured to obtain the search history information of the respective user terminals 10, 20, and 30.

The processor 130 according to an embodiment may be configured to obtain content information of interest of the respective user terminals 10, 20, and 30 based on the obtained search history information.

For example, a search history of the first user terminal 10 may include ‘sports,’ ‘game,’ and the like. In another example, the search history of a second user terminal 20 may include ‘beauty,’ ‘perfume,’ and the like.

Here, the search history may refer to a word, a keyword or the like searched by the main user of the user terminal through a search engine.

The processor 130 according to an embodiment may be configured to identify the content information of interest of the user terminal based on the search history information. In the example described above, based on the search history of the first user terminal 10 including ‘sports,’ ‘game,’ and the like, the processor 130 may be configured to identify ‘sports’ and ‘game’ as the content information of interest of the first user terminal 10. In another example, based on the search history of the second user terminal 20 including ‘beauty,’ ‘perfume,’ and the like, the processor 130 may be configured to identify ‘beauty’ and ‘perfume’ as the content information of interest of the second user terminal 20.

The processor 130 may be configured to obtain the content information of interest of the user terminal based on the content information output by the user terminal, a website address connected through the user terminal, a word included in a screen provided through the user terminal, and the like in addition to the search history of the user terminal.

For example, the processor 130 may be configured to obtain, based on ‘sport,’ ‘soccer,’ ‘league schedule,’ and the like being exposed by a frequency of a threshold value or more in the screen provided through the user terminal, ‘sport,’ soccer,′ and the like of the user terminal as the content information of interest. In the above-described example, the processor 130 provided in the electronic device 100 has been described as obtaining the content information of interest of the user terminal, but this is one embodiment and is not limited thereto. For example, the user terminal may be configured to obtain the content information of interest based on the search history information according to the user input, the content information output by the user terminal itself, the website information the user terminal connected to, the words included in the provided screen, and the like, and then transmit the information and the like to the electronic device 100.

Referring back to FIG. 3, the processor 130 may be configured to obtain an interest score of the respective user terminals 10, 20, and 30 on the content currently being provided based on the content information currently being provided in the display device 200 and the content information of interest of the respective user terminals 10, 20, and 30.

For example, the processor 130 may be configured identify a similarity between the content information currently being provided in the display device 200 and the content information of interest of the respective user terminals 10, 20, and 30.

The processor 130 according to an embodiment may be configured to obtain a similarity value between the name of the content, the genre of the content, the subject of the content, and the like included in the content information currently being provided in the display device 200 and the word (or, keyword) included in the content information of interest of the user terminal. For example, based on the content currently being provided in the display device 200 corresponding to a real-time soccer match, the subject of the content may be ‘sports.’ The processor 130 may be configured to obtain a similarity value between the content information currently being provided in the display device 200 and the content information of interest of the first user terminal 10 from a range of between 0 and 1, and as illustrated in FIG. 4, based on the content information of interest of the first user terminal 10 being ‘sports’ according to the search history information of the first user terminal 10, the processor 130 may be configured to obtain a similarity value close to 1.

In another example, as illustrated in FIG. 4, based on the content information of interest of the second user terminal 20 being ‘beauty’ according to the search history information of the second user terminal 20, the processor 130 may be configured to obtain a similarity value close to 0.

Here, the similarity value may refer to the interest score, and will be collectively referred to as the interest score below for convenience of description.

The processor 130 according to an embodiment may be configured to identify the user terminal which corresponds to the highest score from among the plurality of user terminals 10, 20, and 30 based on the interest score of the respective user terminals 10, 20, and 30.

For example, the processor 130 may be configured to identify the first user terminal 10 as having the highest interest score from among the plurality of user terminals 10, 20, and 30. In this case, the processor 130 may be configured to determine, because a likelihood of the main user of the first user terminal 10 having an interest in the content which is currently being provided in the display device 200 is of the highest, that the main user of the first user terminal 10 is currently using the display device 200.

Then, the processor 130 may be configured to transmit the advertisement information which corresponds to the first user terminal 10 to the display device 200, and the display device 200 may be configured to output an advertisement based on the received advertisement information.

The processor 130 according to an embodiment may be configured to determine, based on the first user terminal 10 being identified as located adjacent to the display device 200, that the main user of the first user terminal 10 is currently using the display device 200.

In another example, the processor 130 may be configured to receive usage time information of the respective user terminals 10, 20, and 30. Here, the usage time information may also be referred to as a usage time distribution, or the like, but will be collectively referred to as the usage time information for convenience of description.

The processor 130 according to an embodiment may be configured to identify, based on the usage time information of the respective user terminals 10, 20, and 30 being received, the user terminal corresponding to the usage time information which includes the time (e.g., current time) at which the advertisement request signal is received from among the plurality of user terminals 10, 20, and 30.

For example, it may be assumed that the current time at which the advertisement request signal is received from the display device 200 is 10:00 AM. The processor 130 may be configured to identify any one user terminal which includes 10:00 AM based on the usage time information of the respective user terminals 10, 20, and 30.

In an example, based on the first user terminal 10 being used mainly from 6:00 PM to 10:00 PM and the first user terminal 10 not being used mainly in the mornings according to the usage time information of the first user terminal 10, the processor 130 may not be configured to identify the main user of the first user terminal 10, which does not include 10:00 AM which is the current time at which the advertisement request signal is received as the usage time information, as currently using the display device 200.

In another example, based on the second user terminal 20 being used mainly from 9:00 AM to 11:00 AM and the second user terminal 20 not being used mainly in the afternoons according to the usage time information of the second user terminal 20, the processor 130 may be configured to identify the main user of the second user terminal 20, which includes 10:00 AM which is the current time at which the advertisement request signal is received as the usage time information, as currently using the display device 200. Then, the processor 130 may be configured to transmit the advertisement information which corresponds to the second user terminal 20 to the display device 200.

In the embodiment described above, although it has been described as identifying the user currently using the display device 200 from among the main users of the respective user terminals 10, 20, and 30 taking into consideration the respective \textcircled{1} current time at which the advertisement request signal is received, \textcircled{2} content information currently being provided through the display device, and \textcircled{3} location information of where the display device 200 is provided independently, the embodiment is one embodiment and is not limited thereto. For example, the user currently using the display device 200 may be identified from among the main users of the respective user terminals 10, 20, and 30 by taking into consideration at least two information from among \textcircled{1} the current time at which the advertisement request signal is received, \textcircled{2} the content information currently being provided through the display device, and \textcircled{3} the location information of where the display device 200 is provided simultaneously or consecutively.

For example, the processor 130 may be configured to identify, based on the content information of interest and the usage time information of the respective user terminals 10, 20, and 30 being obtained, at least one user terminal corresponding to the usage time information which includes the time at which the advertisement request signal is received from among the plurality of user terminals 10, 20, and 30.

Then, the processor 130 may be configured to obtain the interest score of the identified at least one user terminal with respect to the content currently being provided in the display device 200 based on the content information currently being provided in the display device 200 and the content information of interest of the identified at least one user terminal, and identify the one user terminal from among the identified at least one user terminal based on the interest score.

Then, the processor 130 may be configured to transmit the advertisement information which corresponds to the user terminal identified based on information stored in the memory 120 to the display device 200 through the communication interface 110.

FIG. 5 is a diagram illustrating advertisement information stored in an electronic device according to an embodiment of the disclosure.

Referring to FIG. 5, the processor 130 according to an embodiment may be configured to store various data received by performing communication with the respective user terminals 10, 20, and 30 in the memory 120.

In an example, the processor 130 according to an embodiment may be configured to store the usage time information 1 received from the plurality of user terminals 10, 20, and 30 in the memory 120. For example, referring to FIG. 5, the first user terminal 10 (e.g., Phone_1) may have the usage time distribution of between 21:00 and 24:00, and the second user terminal 20 (e.g., Phone_2) may have the usage time distribution of between 12:00 and 24:00.

In addition, the processor 130 may be configured to obtain the content information of interest 2 which corresponds to the respective user terminals 10, 20, and 30 and store in the memory 120.

Referring to FIG. 5, the content information of interest 2 which corresponds to the first user terminal 10 (e.g., Phone_1) may be ‘Sports’ and ‘Game,’ and the content information of interest 2 which corresponds to the second user terminal 20 (e.g., Phone_2) may be ‘Beauty’ and ‘Food.’

The processor 130 according to an embodiment may be configured to obtain the advertisement information 3 corresponding to the user terminal based on the content information of interest 2 of the user terminal and store the information in the memory 120.

For example, as described above, based on the content information of interest 2 corresponding to the first user terminal 10 (e.g., Phone_1) being ‘Sports’ and ‘Game,’ the processor 130 may be configured to store \textcircled{1} ‘A’ shoes, \textcircled{2} ‘B’ basketball, \textcircled{3} ‘C’ mobile game, \textcircled{4} ‘D’ game console . . . as advertisement information 3 corresponding to the first user terminal.

In another example, based on the content information of interest 2 corresponding to the second user terminal 20 (e.g., Phone_2) being ‘Beauty’ and ‘Food,’ the processor 130 may be configured to store \textcircled{1} ‘E’ cosmetic products, \textcircled{2} ‘F’ perfume, \textcircled{3} ‘G’ meal kit, \textcircled{4} ‘H’ game console . . . as advertisement information 3 corresponding to the second user terminal.

According to an embodiment, the processor 130 may be configured to obtain the advertisement information 3 which includes at least one advertisement that corresponds to the user terminal based on the content information of interest 2 of the user terminal, and store the obtained advertisement information 3 in the memory 120.

Accordingly, the processor 130 may be configured to obtain, based on any one user terminal from among the plurality of user terminals 10, 20, and 30 being identified as currently using the display device 200, the advertisement information 3 corresponding to the identified user terminal stored in the memory 120. Then, the processor 130 may be configured to transmit the obtained advertisement information 3 to the display device 200.

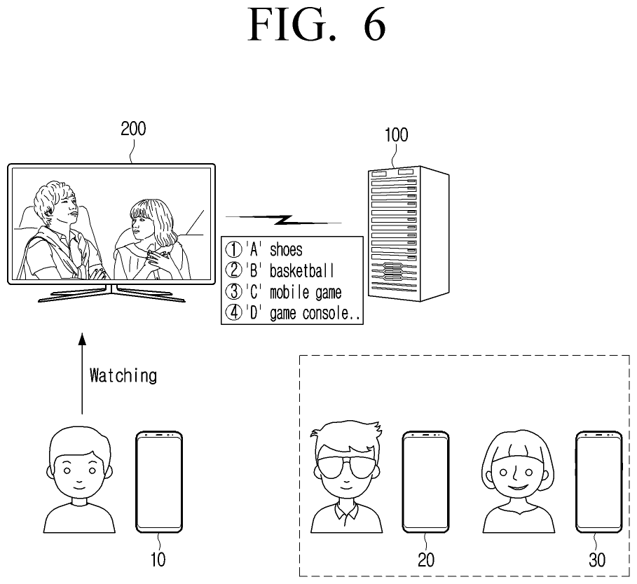

FIG. 6 is a diagram illustrating advertisement information received by a display device according to an embodiment of the disclosure.

FIG. 6 illustrates the processor 130 identifying the first user terminal 10 currently using the display device 200 from among the plurality of user terminals 10, 20, and 30 for convenience of description.

As illustrated in FIG. 5, the processor 130 may be configured to transmit, based on the first user terminal 10 being identified, the advertisement information \textcircled{1} ‘A’ shoes, \textcircled{2} ‘B’ basketball, \textcircled{3} ‘C’ mobile game, \textcircled{4} ‘D’ game console . . . corresponding to the first user terminal 10 to the display device 200.

Then, the display device 200 may be configured to display the advertisement based on the received advertisement information.

The processor 130 according to an embodiment may be configured to identify a plurality of advertisement information and a priority order of the respective advertisement information based on the content information of interest and a user profile information of the respective user terminals 10, 20, and 30.

For example, the processor 130 may be configured to identify the plurality of advertisement information by taking into consideration the user profile information additionally in addition to the content information of interest of the user terminal, and allocate a priority order to the plurality of advertisement information. For example, the user profile information may include a gender, age, and the like of the main user of the user terminal.

The processor 130 may be configured to set a target gender and a target age for the respective advertisements according to the user input, and allocate a priority order of the plurality of advertisement information so as to coincide with the target gender and the target age for the respective advertisements by taking into consideration the user profile information additionally in addition to the content information of interest of the user terminal.

For example, the processor 130 may be configured to allocate, after identifying the plurality of advertisement information which corresponds to the content information of interest, a high priority order based on the target gender and the target age of the respective advertisement information matching with the user profile information, and allocate a low priority order based on at least one from among the target gender or the target age not matching with the user profile information.

In still another example, the processor 130 may be configured to allocate a priority order to the respective advertisement information based on the current time information. For example, the processor 130 may be configured to set a target time for the respective advertisements according to the user input, and allocate a high priority order to any one from among the plurality of advertisement information based on the time at which the advertisement request signal is received from the display device 200. For example, it may be assumed that the target time of a specific advertisement is from 9:00 PM to 11:00 PM. The processor 130 may be configured to allocate, based the time at which the advertisement request signal is received from the display device 200 being between 9:00 PM and 11:00 PM, a high priority order to a specific advertisement and transmit information corresponding to the specific advertisement with the high priority order from among the plurality of advertisement information to the display device 200 as a priority.

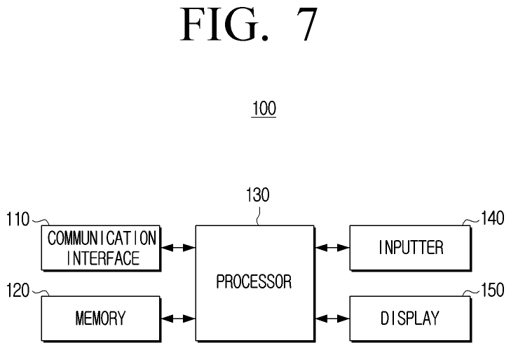

FIG. 7 is a detailed block diagram illustrating a configuration of an electronic device according to an embodiment of the disclosure.

Referring to FIG. 7, the electronic device 100 may include the communication interface 110, the memory 120, the processor 130, an inputter 140, and a display 150. Because the communication interface 110, the memory 120, and the processor 130 has been described in detail in FIG. 2, redundant descriptions will be omitted.

The processor 130 according to an embodiment may be configured to identify at least one user terminal from among the plurality of user terminals by inputting the context information of the display device 200 to a neural network model.

Here, the neural network model may be a model trained to identify at least one sample user terminal which corresponds to the context information of the display device 200 from among a plurality of sample user terminals.

The processor 130 configured to execute an artificial intelligence model according to an embodiment may be implemented through a combination of a generic-purpose processor such as a CPU, an AP, and a digital signal processor (DSP), a graphics dedicated processor such as a GPU and a vision processing unit (VPU), or an artificial intelligence dedicated processor such as an NPU with a software. The processor 130 may control so as to process input data according to a pre-defined operation rule or an artificial intelligence model stored in the memory 120. Alternatively, the processor 130 may be designed, based on being a dedicated processor (or an artificial intelligence dedicated processor), in a hardware structure specializing in the processing of a specific artificial intelligence model. For example, the hardware specializing in the processing of the specific artificial intelligence model may be designed as a hardware chip such as, for example, and without limitation, an ASIC, an FPGA, or the like. Based on the processor 130 being implemented with a dedicated processor, the processor 130 may be implemented to include a memory for implementing the embodiment of the disclosure, or implemented to include a memory processing function for using an external memory.

According to another example, the memory 120 may be configured to store information associated with the artificial intelligence model which includes a plurality of layers. The storing information associated with the artificial intelligence model may mean storing various information associated with an operation of the artificial intelligence model, for example, information on the plurality of layers included in the artificial intelligence model, information on a parameter (e.g., filter coefficient, bias, etc.) used in the respective layers, and the like.

For example, the memory 120 may be configured to store information on the neural network model trained to identify the at least one user terminal which corresponds to the context information of the display device 200 according to an embodiment.

For example, the context information of the neural network model may, as described above, include at least one from among \textcircled{1} the current time at which the advertisement request signal is received, \textcircled{2} the content information currently being provided through the display device 200, and \textcircled{3} location information of where the display device 200 is provided, and the neural network model may be a model trained to identify any one user terminal from among the plurality of user terminals based on the context information.

The artificial intelligence model being trained may refer to a pre-defined operation rule or an artificial intelligence model set to perform a desired feature (or, object) being created by a basic artificial intelligence model (e.g., an artificial intelligence model including arbitrary random parameters) being trained by a learning algorithm using multiple learning data. The training may be performed through a separate server and/or a system, but the embodiment is not limited thereto, and may be performed in the electronic device 100. Examples of the learning algorithm may include, supervised learning, unsupervised learning, semi-supervised learning, transfer learning, or reinforcement learning, but is not limited to the above-described examples.

The respective artificial intelligence models may be implemented with, for example, and without limitation a Convolutional Neural Network (CNN), a Recurrent Neural Network (RNN), a Restricted Boltzmann Machine (RBM), a Deep Belief Network (DBN), a Bidirectional Recurrent Deep Neural Network (BRDNN), a Deep Q-Networks, or the like, but is not limited thereto.

The inputter 140 may refer to means of inputting data for controlling the electronic device 100 by the user. In an example, the processor 130 may be configured to set the target gender, the target age, the target time, and the like of the respective advertisements through the inputter 140, and select any one from among the plurality of user terminals 10, 20, and 30.

The inputter 140 may include a key board, a mouse, a key pad, a touch pad, or the like, but is not limited thereto.

The display 150 may be configured to display various screens.

The display 150 may be implemented as a display including self-emissive devices or as a display including non-emissive devices and a backlight. For example, the display 150 may be implemented to a display of various types such as, for example, and without limitation, a liquid crystal display (LCD), organic light emitting diodes (OLED) display, light emitting diodes (LED), a micro LED, a mini LED, a plasma display panel (PDP), a quantum dot (QD) display, a quantum dot light emitting diodes (QLED), or the like. In the display 150, a driving circuit, which may be implemented in the form of an amorphous silicon (a-si) thin film transister (TFT), a low temperature poly silicon (LTPS) TFT, or an organic TFT (OTFT), a backlight unit, and the like may be included. The display 150 may be implemented as a touch screen coupled with a touch sensor, a flexible display, a rollable display, a third-dimensional display (3D display), a display physically coupled with a plurality of display modules, or the like.

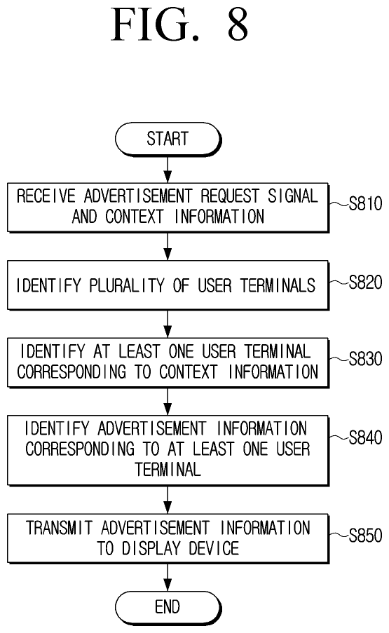

FIG. 8 is a flowchart illustrating a control method of an electronic device according to an embodiment of the disclosure.

Referring to FIG. 8, the control method of the electronic device according to an embodiment may include identifying, based on the advertisement request signal and the context information of the display device being received from the display device at operation S810, identifying the plurality of user terminals associated with the display device at operation S820. Then, the control method may identify at least one user terminal which corresponds to the context information of the display device from among the plurality of user terminals at operation S830.

Then, the advertisement information which corresponds to the user terminal identified based on the stored information may be identified at operation S840.

Then, the identified advertisement information may be transmitted to the display device at operation S850.

Here, the context information of the display device may include the location information of the display device, and the identifying of the at least one user terminal S830 may include identifying, based on the location information being received from the respective user terminals, at least one user terminal device located adjacent to the display device from among the plurality of user terminal devices based on the location information of the display device and the location information of the respective user terminal devices.

The context information of the display device according to an embodiment may include the communication network information of the display device, and the identifying of the at least one user terminal at operation S830 may include identifying, based on the communication network information being received from the respective user terminals, at least one user terminal device located adjacent to the display device from among the plurality of user terminals based on the communication network information of the display device and the communication network information of the respective user terminals.

According to an embodiment, the context information of the display device may include the content information which is currently being provided in the display device, and the identifying of the at least one user terminal at operation S830 may include obtaining, based on the content information of interest of the respective user terminals being obtained, the interest score of the respective user terminals with respect to the content currently being provided based on the content information currently provided in the display device and the content information of interest of the respective user terminals and identifying at least one user terminal device from among the plurality of user terminals based on the interest score.

The identifying of the at least one user terminal at operation S830 may include obtaining the search history information of the respective user terminals and identifying the content information of interest of the respective user terminals based on the obtained search history information.

The identifying of the at least one user terminal at operation S830 according to an embodiment may include identifying, based on the usage time information of the respective user terminals being received, the user terminal corresponding to the usage time information which includes the time at which the advertisement request signal is received from among the plurality of user terminals.

The identifying of the at least one user terminal at operation S830 according to an embodiment may include identifying, based on the content information of interest and the usage tie information of the respective user terminals being obtained, at least one user terminal corresponding to the usage time information which includes the time at which the advertisement request signal is received from among the plurality of user terminals, obtaining the interest scores of the identified at least one user terminal with respect to the content currently being provided based on the content information currently being provided in the display device and the content information of interest of the identified at least one user terminal, and identifying one user terminal from among the identified at least one user terminal based on the interest score.

The identifying of the advertisement information at operation S840 according to an embodiment may include identifying, based on the content information of interest and the user profile information of the respective user terminals being obtained, the plurality of advertisement information and the priority order of the respective advertisement information based on the content information of interest and the user profile information of the respective user terminals, and the transmitting at operation S850 may include transmitting the plurality of advertisement information to the display device consecutively based on the priority order.

Here, the identifying of the priority order may include identifying the plurality of advertisement information and the priority order of the respective advertisement information based on the content information of interest, the user profile information, and the current time information of the respective user terminals.

The identifying of the user terminal at operation S830 according to an embodiment may include identifying at least one user terminal from among the plurality of user terminals by inputting the context information of the display device to the neural network model, and the neural network model may be a model trained to identify at least one user terminal which corresponds to the context information of the display device from among the plurality of user terminals.

However, the various embodiments of the disclosure are not only applicable to the electronic device, but also to all electronic devices capable of image processing such as, for example, and without limitation, a display device, and the like.

The various embodiments described above may be implemented in a recordable medium which is readable by a computer or a device similar to a computer using a software, a hardware, or the combination of the software and the hardware. In some cases, the embodiments described herein may be implemented by the processor itself. According to a software implementation, embodiments such as the procedures and functions described herein may be implemented with separate software modules. The respective software modules may perform one or more functions and operations described herein.

Computer instructions for performing the processing operations of the sound output device 100 according to the various embodiments described above may be stored in a non-transitory computer-readable medium. The computer instructions stored in this non-transitory computer-readable medium may cause a specific device to perform the processing operations in the sound output device 100 according to the above-described various embodiments when executed by the processor of the specific device.

The non-transitory computer readable medium may refer to a medium that stores data semi-permanently rather than storing data for a very short time, such as a register, a cache, a memory, or the like, and is readable by a device. Specific examples of the non-transitory computer readable medium may include, for example, and without limitation, a compact disc (CD), a DVD, a hard disc, a Blu-ray disc, a USB, a memory card, a ROM, and the like.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a communication interface;
a memory storing information corresponding to a plurality of user terminals, respectively; and
a processor configured to:
identify, based on an advertisement request signal and context information of a display device being received from the display device, at least one user terminal corresponding to context information of the display device from among the plurality of user terminals,
identify advertisement information corresponding to the identified at least one user terminal based on the stored information, and
transmit the identified advertisement information to the display device through the communication interface.

2. The electronic device of claim 1,
wherein the context information of the display device comprises location information of the display device, and
wherein the processor is further configured to:
identify, based on the location information being received from the respective user terminals, the at least one user terminal located adjacent to the display device from among the plurality of user terminals based on the location information of the display device and the location information of the respective user terminals, and
transmit the advertisement information corresponding to the identified user terminal based on the stored information as the identified advertisement information to the display device through the communication interface.

3. The electronic device of claim 1,
wherein the context information of the display device comprises communication network information of the display device, and
wherein the processor is further configured to:
identify, based on the communication network information being received from the respective user terminals, the at least one user terminal located adjacent to the display device from among the plurality of user terminals based on the communication network information of the display device and the communication network information of the respective user terminals, and
transmit the advertisement information corresponding to the identified user terminal based on the stored information as the identified advertisement information to the display device through the communication interface.

4. The electronic device of claim 1,
wherein the context information of the display device comprises content information currently being provided in the display device, and
wherein the processor is further configured to:
obtain, based on content information of interest of the respective user terminals being obtained, an interest score of the respective user terminals with respect to a content currently being provided based on the content information currently being provided in the display device and the content information of interest of the respective user terminals,
identify the at least one user terminal from among the plurality of user terminals based on the interest score, and
transmit the advertisement information corresponding to the identified user terminal based on the stored information as the identified advertisement information to the display device through the communication interface.

5. The electronic device of claim 4, wherein the processor is further configured to:
obtain search history information of the respective user terminals; and
identify the content information of interest of the respective user terminals based on the obtained search history information.

6. The electronic device of claim 1, wherein the processor is further configured to:
identify, based on usage time information of the respective user terminals being received, the user terminal corresponding to usage time information which includes a time at which the advertisement request signal is received from among the plurality of user terminals; and
transmit the advertisement information corresponding to the identified user terminal based on the stored information as the identified advertisement information to the display device through the communication interface.

7. The electronic device of claim 1, wherein the processor is further configured to:
identify, based on content information of interest and usage time information of the respective user terminals being obtained, the at least one user terminal corresponding to the usage time information which includes a time at which the advertisement request signal is received from among the plurality of user terminals;
obtain an interest score of the identified at least one user terminal with respect to content currently being provided based on content information currently being provided in the display device and content information of interest of the identified at least one user terminal;
identify one user terminal from among the identified at least one user terminal based on the interest score; and
transmit advertisement information corresponding to the identified one user terminal based on the stored information to the display device through the communication interface.

8. The electronic device of claim 1, wherein the processor is further configured to:
identify, based on content information of interest and user profile information of the respective user terminals being obtained, a plurality of advertisement information and a priority order of the respective advertisement information based on the content information of interest and the user profile information of the respective user terminals; and
transmit the plurality of advertisement information to the display device consecutively based on the priority order through the communication interface.

9. The electronic device of claim 8, wherein the processor is further configured to identify the plurality of advertisement information and the priority order of the respective advertisement information based on the content information of interest, the user profile information, and current time information of the respective user terminals.

10. The electronic device of claim 1, wherein the processor is further configured to:
identify the at least one user terminal from among the plurality of user terminals by inputting context information of the display device to a neural network model, and
wherein the neural network model is trained to identify the at least one user terminal corresponding to context information of the display device from among the plurality of user terminals.

11. A control method of an electronic device storing information corresponding to a plurality of user terminals respectively, the control method comprising:
identifying, based on an advertisement request signal and context information of a display device being received from the display device, at least one user terminal corresponding to context information of the display device from among the plurality of user terminals;
identifying advertisement information corresponding to the identified at least one user terminal based on the stored information; and
transmitting the identified advertisement information to the display device.

12. The method of claim 11,
wherein the context information of the display device comprises location information of the display device, and
wherein the identifying of the at least one user terminal comprises identifying, based on location information being received from the respective user terminals, the at least one user terminal located adjacent to the display device from among the plurality of user terminals based on the location information of the display device and the location information of the respective user terminals.

13. The method of claim 11,
wherein the context information of the display device comprises communication network information of the display device, and
wherein the identifying of the at least one user terminal comprises identifying, based on communication network information being received from the respective user terminals, the at least one user terminal located adjacent to the display device from among the plurality of user terminals based on the communication network information of the display device and the communication network information of the respective user terminals.

14. The method of claim 11,
wherein the context information of the display device comprises content information currently being provided in the display device, and
wherein the identifying of the at least one user terminal comprises:
obtaining, based on content information of interest of the respective user terminals being obtained, an interest score of the respective user terminals with respect to a content currently being provided based on the content information currently being provided in the display device and the content information of interest of the respective user terminals, and
identifying the at least one user terminal from among the plurality of user terminals based on the interest score.

15. The method of claim 14, wherein the identifying of the at least one user terminal comprises:
obtaining search history information of the respective user terminals; and
identifying the content information of interest of the respective user terminals based on the obtained search history information.

16. The method of claim 11, wherein the identifying of the at least one user terminal comprises:
identifying, based on usage time information of the respective user terminals being received, the user terminal corresponding to usage time information which includes a time at which the advertisement request signal is received from among the plurality of user terminals.

17. The method of claim 11, wherein the identifying of the at least one user terminal comprises:
identifying, based on content information of interest and usage time information of the respective user terminals being obtained, the at least one user terminal corresponding to the usage time information which includes a time at which the advertisement request signal is received from among the plurality of user terminals;
obtaining an interest score of the identified at least one user terminal with respect to content currently being provided based on content information currently being provided in the display device and content information of interest of the identified at least one user terminal; and
identifying one user terminal from among the identified at least one user terminal based on the interest score.

18. The method of claim 11,
wherein the identifying of the at least one user terminal comprises identifying, based on content information of interest and user profile information of the respective user terminals being obtained, a plurality of advertisement information and a priority order of the respective advertisement information based on the content information of interest and the user profile information of the respective user terminals, and
wherein the transmitting comprises transmitting the plurality of advertisement information to the display device consecutively based on the priority order through the display device.

19. The method of claim 18, wherein the identifying the plurality of advertisement information and the priority order comprises identifying the plurality of advertisement information and the priority order of the respective advertisement information based on the content information of interest, the user profile information, and current time information of the respective user terminals.

20. The method of claim 11,
wherein the identifying of the at least one user terminal comprises identifying the at least one user terminal from among the plurality of user terminals by inputting context information of the display device to a neural network model, and
wherein the neural network model is trained to identify the at least one user terminal corresponding to context information of the display device from among the plurality of user terminals.
